(19) United States
(12) Patent Application Publication
(10) Pub. No.: US 2026/0203266 A1
(43) Pub. Date: Jul. 16, 2026

(54) SYSTEMS AND METHODS FOR BUILDING AND UTILIZING K-DIMENSIONAL COMPLETE POINTER-FREE TREES

(71) Applicant: NISSAN NORTH AMERICA, INC., Franklin, TN (US)

(72) Inventor: David Marshall ILSTRUP, Santa Cruz, CA (US)

(21) Appl. No.: 19/025,686

(22) Filed: Jan. 16, 2025

(51) Int. Cl. G06F 16/22; G06F 12/02

(52) U.S. Cl. CPC G06F 16/2246; G06F 12/0238

(57) ABSTRACT

Systems and methods for building and utilizing a k-dimensional tree that is complete and pointer-free tree are disclosed herein. In an embodiment, the method includes determining a relative magnitude between (i) half of a high-bit number being the largest number that is a power of two less than or equal to the number of data points at respective node, and (ii) the difference between the number of data points and the high-bit number, splitting the respective node with a hyperplane that places a number of points on the left side of the hyperplane equal to (a) the high-bit number or (b) the sum of half of the high-bit number and the difference between the number of data points and the high-bit number, until each branch of the KD-CPF tree terminates at a leaf node.

### BACKGROUND

### Field of the Disclosure

The present disclosure generally relates to systems and methods for building and utilizing a k-dimensional tree (“k-d tree”) that is a complete and pointer-free tree.

### Background Information

A k-d tree is a binary tree with nodes representing splitting planes and k-dimensional points in a k-dimensional space. A k-d tree is typically said to have a “root” node, “child” nodes and “leaf” nodes. The root node generally refers to the initial or largest node that represents the entire dataset and which initially divides the k-dimensional space into two parts. Each child node (or “non-leaf” node) then further subdivides the k-dimensional space into two even smaller parts, with the leaf nodes being the terminal nodes at the end of each branch created by recursively splitting the child nodes. The “left sub-tree” generally refers to the subset of points that lie on one side of the hyperplane splitting the point set (i.e., to the left), while the “right sub-tree” generally refers to the subset of points that lie on the other side of the hyperplane. A k-d tree is “left-balanced” or “complete” when the entire topology can be encoded by arranging the nodes in proper order without gaps.

Over time, k-d tree variants have evolved to address different application requirements and execution environments. A typical approach to pointer-free k-d trees is to implement a contiguous binary tree to record the values used at each level of the search. Such a k-d tree is built by cycling through each of the k-dimensions and using the median as the hyperplane to divide the space. A negative effect of splitting sub-trees at the median key is that significant gaps occur in the data structure except for special values of n (the number of input points).

Alternative approaches avoid gaps using a workaround such as adjusting n to a power of 2 (or 2\hat{ }n−1), which results in a complete binary k-d tree when using median selection to partition the data but also requires modifying the point set used to define the k-d tree. More elaborate workarounds include embedding offsets into the k-d tree to jump around gaps, but these workarounds are unsatisfactory since they add to space requirements and code complexity.

### SUMMARY

The present disclosure provides systems and methods for building and utilizing a k-dimensional complete pointer-free tree (“KD-CPF Tree”). A KD-CPF Tree as described herein improves the median selection method used in existing methods. The disclosed methods make no assumptions about the size of the input, but instead consider the cardinality of each sub-tree to split at an index that results in a complete tree while preserving search speed.

The disclosed KD-CPF Tree is complete in that there are no gaps regardless of tree size. Gaps in a k-d tree result in wasted memory space. The disclosed KD-CPF Tree requires exactly n-1 contiguous non-leaf entries for an input data set of n points.

The disclosed KD-CPF Tree is balanced in that the maximum depth to get to a leaf node varies by at most 1, resulting in faster searches because the number of nodes to reach to a leaf node is reduced. For a KD-CPF Tree built from N points, the maximum search depth is the “ceiling of log2(N)” and the minimum search depth is the “floor of log 2(N)”. When N is not a power of 2, the difference is 1 and when N is a power of 2 the difference is 0.

The disclosed KD-CPF Tree is pointer-free in that it does not rely on pointers that define the tree structure by pointing to another node in the tree based on the splitting dimension at that level. Being pointer-free enables the disclosed KD-CPF Tree image to be flashed onto memory and be directly usable at runtime with no further processing. Pointers are not suitable for shared data, since a single shared memory region is typically mapped to different addresses in different processes. The disclosed KD-CPF Tree therefore saves memory, makes run time more efficient, and can be static (i.e., can be built once and then used repeatedly without restriction to the compute process where it is built).

The systems and methods disclosed herein thus generate a compact, pointer-free memory image with a simple, fast implementation for k-d tree building and searching. The disclosed systems and methods generate a complete binary k-d tree for any sized input, producing a memory image with no wasted space. The disclosed systems and methods utilize a memory allocation scheme that builds the KD-CPF Tree in-place with a node indexing scheme that produces a 1-1 match between input data points and leaves.

The disclosed KD-CPF Tree can also use typical stack requirements such as O(log n) space. Alternatively, stack free methods can be adapted for the disclosed KD-CPF Tree, for example by modifying a sub-tree iterator and replacing the call stack with arithmetic rules that follow complete pointer free selection as disclosed herein.

A KD-CPF Tree generated as described herein provides several practical and technical advantages. Among other advantages, the disclosed KD-CPF Tree can be created once and then used with many systems, such as the electronic control units for vehicles in a cloud-based fleet. The disclosed KD-CPF Tree has a pointer-free image that allows instant use off-the-wire, and the compact nature of the image supports efficient network transmission. The disclosed KD-CPF Tree can also be scaled to any size point-set to facilitate updates in real-time or offline. The disclosed KD-CPF Tree reduces memory requirements and improves search processing efficiency, for example, in comparison to k-d trees using median selection or other workarounds.

Additionally, vehicle applications often require embedded environments (e.g., ECUs). Autonomous driving applications also often make use of graphics processing units (“GPU”) and often use shared memory for resource intensive data (e.g., point clouds). Shared memories and GPUs require pointer-free k-d trees and must avoid wasting memory space, making a KD-CPF generated as described herein particularly advantageous for vehicle applications.

In view of the state of the known technology, one aspect of the present disclosure is to provide a computer-implemented method of building a KD-CPF tree for a plurality of data points. The method includes determining a number of data points for constructing a KD-CPF tree having a plurality of splitting nodes and a plurality of leaf nodes, for each respective splitting node of the plurality of splitting nodes, determining a relative magnitude between (i) half of a high-bit number that is the largest number being a power of two that is less than or equal to the number of data points at the respective splitting node, and (ii) the difference between the number of data points at the respective splitting node and the high-bit number, based on the relative magnitude, splitting each of the respective splitting nodes with a hyperplane that places a number of points on the left side of the hyperplane equal to one of (a) the high-bit number or (b) a sum of half of the high-bit number and the difference between the number of data points at the respective splitting node and the high-bit number, until each branch of the KD-CPF tree terminates at a leaf node, and storing locations of the leaf nodes and the hyperplanes in a memory accessible for a search of data associated with the data points.

A second aspect of the present disclosure is to provide a non-transitory machine-readable medium storing source code instructions which, when executed by one or more processors, cause the one or more processors to build a k-dimensional complete pointer-free tree (“KD-CPF tree”) for a plurality of data points. The non-transitory machine-readable medium stores source code instructions including a memory layout defining a first memory location, a second memory location, and a value indicating a number of data points. The non-transitory machine-readable medium also stores a hyperplane selection function configured to build the first memory location and the second memory location by recursively splitting a plurality of respective nodes using a test based on a relative magnitude between (i) half of a high-bit number that is the largest number being a power of two that is less than or equal to a number of data points of the respective node, and (ii) the difference between the number of data points at the respective node and the high-bit number.

A third aspect of the present disclosure is to provide a computer-implemented method of searching a k-dimensional complete pointer-free tree (“KD-CPF tree”). The method includes storing a KD-CPF tree that defines splitting hyperplanes for a plurality of respective nodes using a test based on a relative magnitude between (i) half of a high-bit number that is the largest number being a power of two that is less than or equal to a number of data points of the respective node, and (ii) the difference between the number of data points at the respective node and the high-bit number, searching the KD-CPF tree using a radius search or a k-nearest neighbor search, and outputting results of the radius search or the k-nearest neighbor search.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a system configured to build and utilize a KD-CPF Tree in accordance with the present disclosure;

FIG. 2 illustrates an example embodiment of a method of building and/or utilizing a KD-CPF Tree in accordance with the present disclosure;

FIGS. 3A and 3B illustrate an example embodiment of a method of building a KD-CPF Tree in accordance with the present disclosure;

FIGS. 4A and 4B compare a prior art k-d tree built by a median selection process (FIG. 4A) with a KD-CPF Tree built in accordance with the present disclosure (FIG. 4B);

FIGS. 5A and 5B illustrate an alternative example embodiment of a method of building a KD-CPF Tree in accordance with the present disclosure;

FIGS. 6A to 6C illustrates an example embodiment of a radius searching method that can be performed using a KD-CPF Tree built in accordance with the present disclosure;

FIGS. 7A to 7C illustrate an example embodiment of a k-nearest neighbor (“knn”) searching method that can be performed using a KD-CPF Tree built in accordance with the present disclosure;

FIG. 8 illustrates example embodiments of priority queue implementations supporting the knn searching method illustrated in FIG. 8; and

FIG. 9 illustrates an example embodiment of a vehicle system configured to utilize a KD-CPF Tree built in accordance with the present disclosure to improve map use and/or autonomous driving.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

The present disclosure provides systems and methods for building and utilizing a k-dimensional complete pointer-free tree (“KD-CPF Tree”) for a variety of computer applications. The examples described herein generally relate to vehicle applications such as navigation assistance and autonomous driving which rely on very large data sets (e.g., map data), but those of ordinary skill in the art will recognize from this disclosure that KD-CPF Trees built as described herein can generally be used in place of any existing k-d tree to improve memory allocation and search processing efficiency. The vehicle application examples are not intended to be limiting, but instead to provide context for understanding certain practical and technological advantages of building and searching a KD-CPF Tree as described herein.

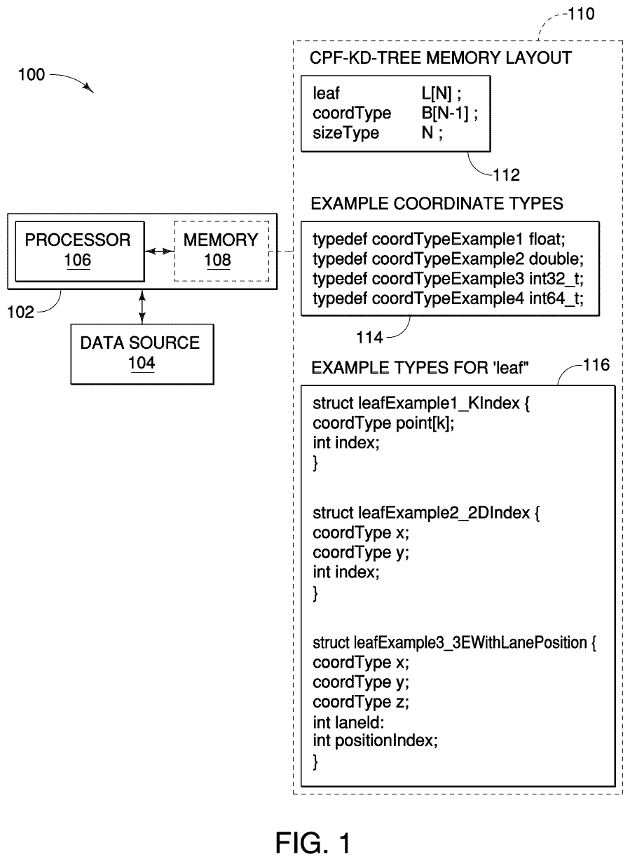

FIG. 1 illustrates an example embodiment of a system 100 configured to build and utilize a KD-CPF Tree in accordance with the present disclosure. In the illustrated embodiment, the system 100 includes a control unit 102 and a data source 104. The control unit 102 includes one or more processor 106 and one or more memory 108. The processor 106 is configured to execute instructions stored on the memory 108 to build and utilize a KD-CPF Tree as described herein. The system 100 is advantageous, for example, in shared memory applications where multiple processes and threads use a single k-d tree memory image, such as GPUs and embedded systems.

The control unit 102 can be any processing/control unit that is capable of building and utilizing a KD-CPF Tree as described herein. For example, the control unit 102 can include a central processing unit (“CPU”), a graphics processing unit (“GPU”), an electronic control unit (“ECU”), or another type of processing/control unit. In an embodiment described in more detail below, the control unit 102 includes a vehicle's ECU, for example, an ECU configured to assist a driver with navigation or to be used for partial or complete autonomous driving. The systems and methods discussed herein are particularly advantageous for use with a fleet of vehicles, which can store machine-readable instructions for building a KD-CPF Tree on the fly and/or can efficiently store and search one or more KD-CPF Trees which rely on cloud data.

The data source 104 can include any data source, whether local, remote, or a combination thereof. The data source 104 defines the data points and the data associated with the points as further described below. In the vehicle example discussed below, the data source 104 includes a plurality of data sources such as local and nonlocal systems and modules that provide map data to a vehicle ECU.

The processor 106 can include one or more processors, such as one or more special purpose processors, one or more digital signal processors, one or more microprocessors, and/or one or more other processors as known in the art. The memory 108 can include a non-transitory machine-readable medium storing instruction which, when executed by the processor 106, build and/or utilize a KD-CPF Tree as described herein. The memory 108 can include any computer useable or computer readable medium or device that can contain, store, communicate or transport any signal or information that can be used with any processor 106. For example, a memory can include one or more read only memory (ROM), random access memory (RAM), one or more other memory and/or combinations thereof.

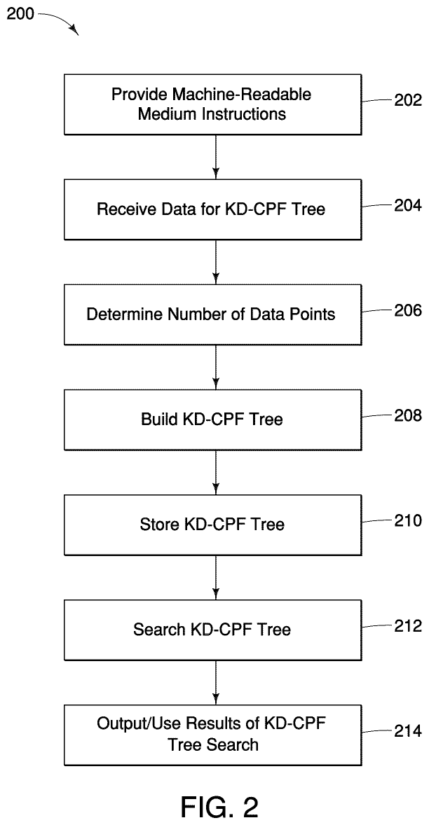

FIG. 2 illustrates an example embodiment of a computer-implemented method 200 of building and utilizing a KD-CPF Tree in accordance with the present disclosure. The steps of the method 200 are generally performed by the control unit 102 using the processor 106 to execute machine-readable instructions stored on the memory 108 that is a non-transitory machine-readable medium. Those of ordinary skill in the art will recognize from this disclosure that certain steps of the method 200 can be omitted, added or altered without departing from the spirit and scope of the method 200.

The method 200 begins at step 202 by providing or inputting source code for machine-readable instructions for generating a KD-CPF Tree in accordance with the present disclosure. The machine-readable instructions are provided on a non-transitory machine-readable medium 108. One advantage of the KD-CPF Tree building process described herein is that the same machine-readable instructions can be saved on a plurality of non-transitory machine-readable mediums, and then the machine-readable instructions can be flexibly used to build different KD-CPF Trees for different applications as needed.

In a vehicle embodiment, a generic set of source code for machine-readable instructions for building a KD-CPF Tree and/or including a KD-CPF Tree built as described herein can be provided to each vehicle in a fleet. Each vehicle in the fleet can then use the machine-readable instructions to build and/or search KD-CPF Trees as needed for the controls specific to that vehicle. For example, when the vehicles in the fleet are shipped to different locations, the machine-readable instructions can be used to build and/or search KD-CPF Trees relevant to map information in each vehicle's respective location. Each vehicle in the fleet can also utilize an already built KD-CPF Tree for navigation in the respective location. Being able to copy the KD-CPF Tree data itself to fleet vehicles to be used as-is is a key advantage of a KD-CPF Tree as disclosed herein.

FIG. 1 illustrates an example embodiment of a non-transitory machine-readable medium 108 storing machine-readable instructions with source code for building a KD-CPF Tree. Here, the machine-readable instructions include an example data layout 110 which defines a memory layout 112, a coordinate type 114 and a data type (or “leaf type”) 116. Those of ordinary skill in the art will recognize from this disclosure that this is an example of machine-readable instructions that will build a KD-CPF Tree as described herein, and that alterations can be made without departing from the spirit and scope of the present disclosure. FIG. 1 presents the machine-readable instructions in terms of several example variants that can be used in practice.

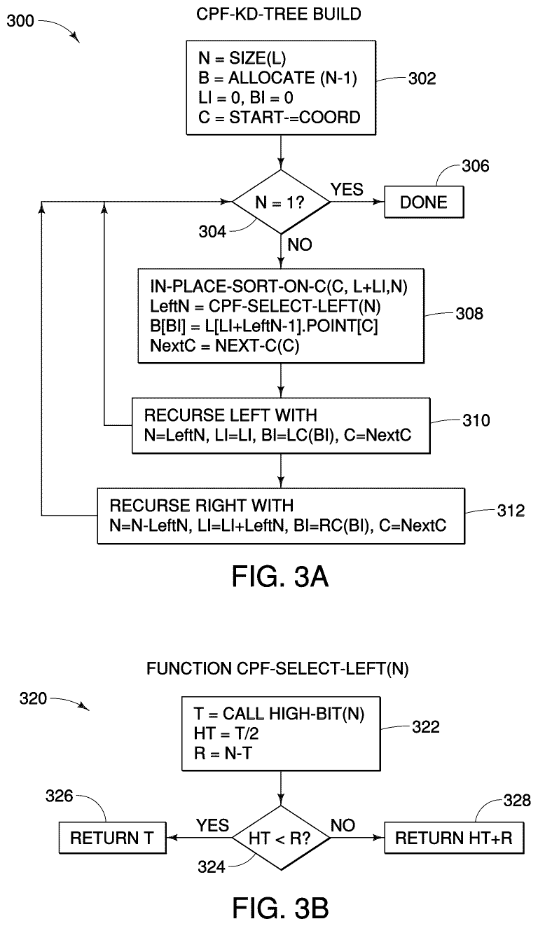

In the illustrated embodiment, the memory layout 112 defines a first memory location, a second memory location, and a value indicating a number of data points. More specifically, the memory layout 112 defined two contiguous memory locations L and B, along with a value N indicating the number of data points (i.e., number of “leaves”) in the memory location L. The memory locations L and B are flat arrays of data. The values L, B and N taken together define the memory layout 112 for the KD-CPF Tree. As described in more detail below, the values L and N are inputs to the tree-building methods illustrated in FIGS. 3 to 5. An advantage of the disclosed methods is that they reorder the records (leaves) in L but allocate no additional memory. That is, L occupies the same memory before and after executing the methods described herein, and the size of a memory location for KD-CPF tree can be defined before the nodes are split based on the number of data points.

In the illustrated embodiment, “L” is a mnemonic for “leaves,” with each element of “L” being a “leaf.” That is, L is an array of N leaf records arranged contiguously in the memory 108. Each L generally contains a point and data associated with the point (e.g., application specific information). Within these constraints, the definition of “leaf” can vary in practice according to the requirements of different applications. Here, the data point (or “leaf point”) is determined by the coordinate type 114 in the memory 108, and the data associated with the point is determined by the data type (or “leaf type”) 116 in the memory 108.

Each leaf point has k coordinates. That is, each leaf is “k-dimensional.” The coordinate type can be any numeric type used to express point coordinates in a software system. Typical types used in practice are signed two's complement integer values and various IEEE754 floating point values. Other types (e.g. fixed-point numbers) can also be used. The coordinate types 114 illustrated in FIG. 1 provide several examples (e.g., float, double, int32_t, int_64t).

The data associated with each leaf point can be an index into an array of information or an object identifier or key into an associative memory or database key. One example is an unsigned two's compliment number indexing an array of data elements (e.g. array of lanes in the vehicle example). Another example is an integer key into a collection of any sort (e.g., data including stop-signs or traffic-lights, lane objects, etc. in the vehicle example). The data associated with each leaf point can also be the actual data associated with a point (e.g., lane identification, lane curvature, lane width, marker paint, etc. in the vehicle example). In an embodiment, many different fields are part of the leaf structure definition (e.g., all of lane identification, lane curvature, lane width, marker paint, etc.). The particular design choice (actual data) is often made when the memory footprint of the associated data is small and the application dictates running KD-CPF Tree queries at a high rate.

The example leaf types 116 in FIG. 1 reflect different types of variations. In the first example, the leaf index (leafExample1_KIndex) includes a k-dimensional point represented as an array of coordinates, with the associated data represented as an index into an array of data stored elsewhere. In the second example, the leaf index (‘leafExample2_2DIndex’) includes a 2-dimensional point represented as coordinate fields x and y, with the associated data represented as an index into an array of associated data stored elsewhere. In the third example, the leaf index (‘leafExample3_3EWithLanePosition’) includes a k-dimensional point represented as an array of coordinates, with the associated data represented as an index into some array of associated data stored elsewhere. In another embodiment, if for any reason L cannot be modified, a variant algorithm can allocate LL containing only index information, which creates a KD-CPF Tree including B, LL and N, where LL refers to L for point data.

Referring again to the memory layout 112, B is a mnemonic for a “binary tree,” namely, a binary tree of alternating coordinate values chosen to partition a query space for a search. Here, B is an array of N−1 coordinate-type values arranged contiguously in the memory 108 for an input data set of N data points. This means that elements of B have the same data type as coordinates of the leaf points. B can be allocated before or as the first step of the methods illustrated in FIGS. 3 to 5. Using the methods described herein, the control unit 102 can define B with an allocated space for N−1 coordinate elements because the space of B will not change since the KD-CPF Tree building methods described herein do not requiring padding or discarding any data points.

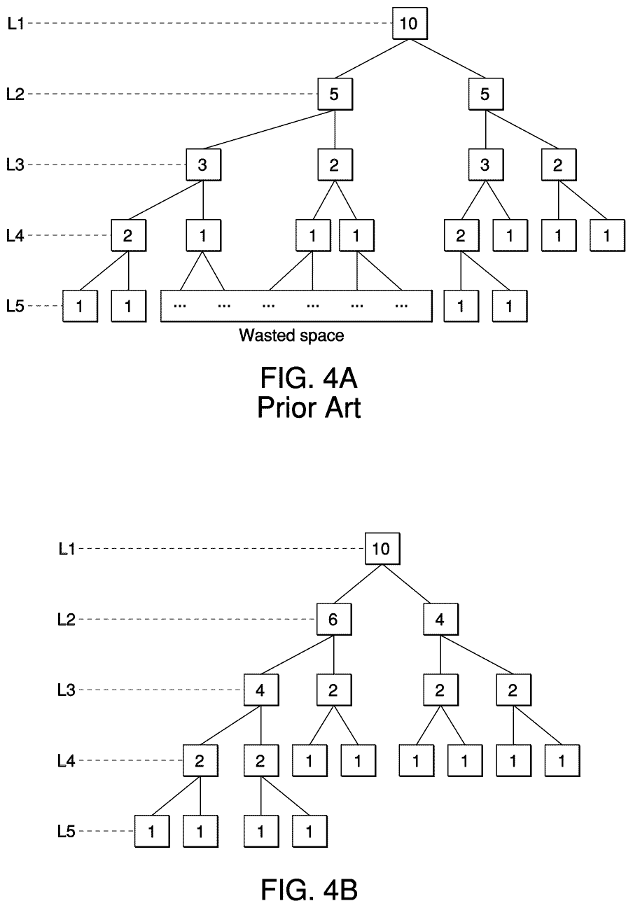

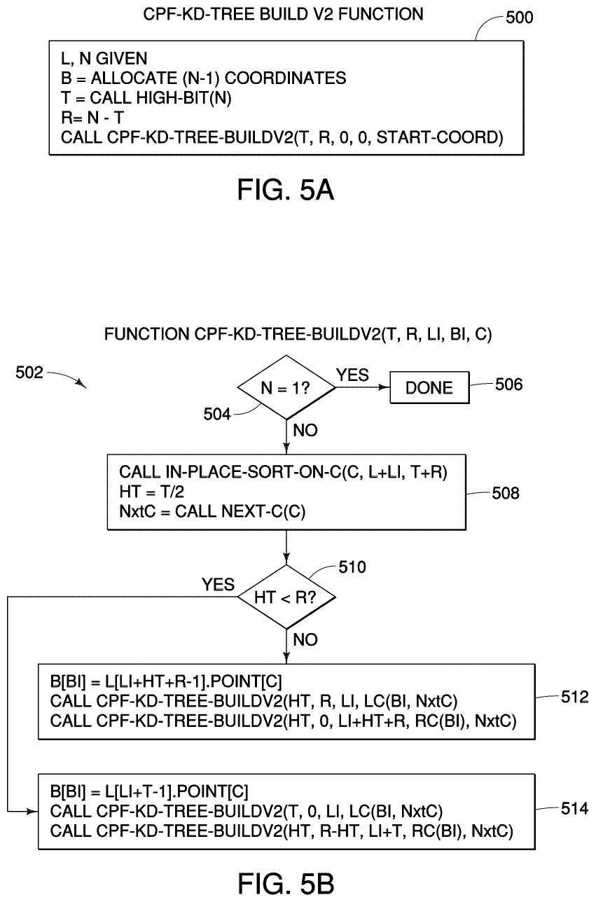

The value N and the coordinate type 114 are necessary and sufficient to allocate B. One common variant in a memory 108 stores a value N at a location zero (0) of B. In this embodiment, N elements are allocated for B and elements of B are stored at locations one (1) to N. The size type of N and the coordinate type of elements in B typically have identical storage requirements. In the methods shown in FIGS. 3 and 5, for example, LC(N) and RC(N) can be computed as 2*N and 2*N+1 respectively and index one (1) in B can be referred to as the “root” of the tree B (i.e., the top node in FIGS. 4A and 4B discussed below). In an example variant where zero (0) is used as the root of B, LC(N) and RC(N) can be computed as 2*N+1 and 2 *N+2 respectively.

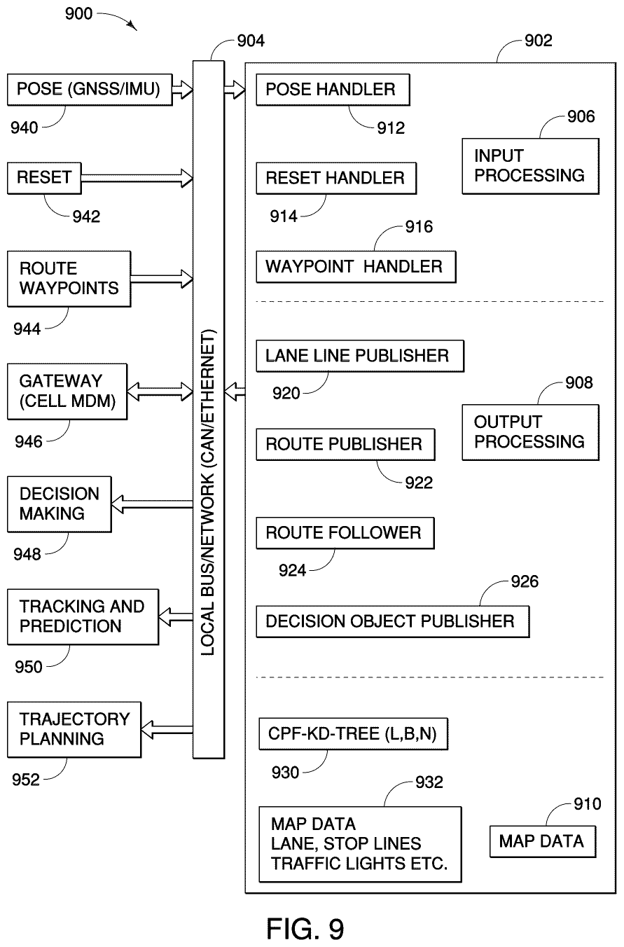

Referring to FIG. 2, the control unit 102 at step 204 receives the data that will be used to build the KD-CPF Tree. The data can be received from one or more local data sources 104, from one or more remote data sources 104, and/or from a combination of local and remote data sources 102. The received data can include data points, data associated with each point, an index into an array of associated data stored elsewhere, or other types of data. An advantage of the KD-CPF Tree building methods described herein is that they can be applied to a wide variety of data types. FIG. 9 discussed below provides various examples of data types and data sources for a vehicle ECU embodiment.

At step 206 of the method 200, the processor 106 determines the number of data points used to define N and thus allocate B as described herein. The number of data points used to define N can be known to the processor 106, or the number of data points used to define N can be computed by the processor 106 based on the data received.

At step 208, the processor 106 builds a KD-CPF Tree that is specific to the data in the data source 104. In doing so, the processor 106 executes a recursive hyperplane selection function that builds the memory locations L and B by recursively splitting a plurality of respective nodes using a test based on a relative magnitude between (i) half of a high-bit number that is the largest number being a power of two that is less than or equal to a number of data points of the respective node, and (ii) the difference between the number of data points at the respective node and the high-bit number.

FIGS. 3A and 3B illustrate a first example embodiment of a method of building a KD-CPF Tree in accordance with the present disclosure. FIGS. 4A and 4B illustrate how a KD-CPF Tree built as described herein reduces memory requirements in comparison to a typical k-d tree built using median selection. FIGS. 5A and 5B illustrate second example embodiment of a method of building a KD-CPF Tree that is a variant of the first embodiment but applies the same general functions when splitting nodes. The steps of the methods shown in FIGS. 3 and 5 are generally performed by the control unit 102 using the processor 106 to execute machine-readable instructions stored on the memory 108.

Referring first to FIG. 3A, an example embodiment of a method 300 of building a KD-CPF Tree is illustrated in terms of a KD-CPF Tree building algorithm (KPF-KD-TREE BUILD). Those of ordinary skill in the art will recognize from this disclosure that this algorithm is an example only and that variations are also possible without departing from the spirit and scope of the disclosed method.

The method 300 generally begins with a memory layout 112, for example, as illustrated in FIG. 1. At step 302, L and N are defined as inputs as described above. Here, the leaf index (LI) and the binary tree index (BI) are initialized to zero (0). Appropriate memory is allocated for B, knowing that the space of B will not change because the methods described herein do not requiring padding or discarding data points. The initial value of the sorting dimension C (START-COORD) is chosen to create the first splitting hyperplane for the KD-CPF Tree. For example, “x” is typically chosen to initialize C in a low-dimension geometry such as is used with map data.

Alternatively, at step 302, one (1) can be used as the root of B, and BI can be initialized to one (1), and appropriate modifications made to the algorithms disclosed herein. For example, different computation for LC( ) and RC( ) can be used, and the location B[0] can be used to store N, with the tree is saved as B, L instead of B, L, N.

Once the variables are set, the processor 106 makes a call to the KD-CPF Tree building algorithm with these initial values. At steps 310 and 312, the processor 106 executes recursive calls until reaching a termination condition at step 304 (here, N=1). That is, once N reaches the value one (1), there is no work remaining and the algorithm returns at step 306, which expresses the completion logic when the algorithm is done and the KD-CPF Tree is complete.

At step 308, the processor 106 executes a basic set of operations done on calls to the KD-CPF Tree building algorithm. A first operation (shown as IN-PLACE-SORT-ON-C) compares a coordinate C of points in L to determine the sort order. The sort is done over N points starting at an offset LI in the array L. In an embodiment, this step can be implemented as a paired priority queue for a dynamic M-th order statistic for B[BI], which guarantees that all elements in the left sub-tree of the KD-CPF Tree are less than or equal to B[BI], and that all elements in the right sub-tree of the KD-CPF Tree are greater than or equal to B[BI]. Sorting is a strictly stronger property that may be preferable to minimize code size when a sorting library is already available. For each of these methods, L is modified in-place by iteratively swapping elements of L. Here, the KD-CPF Tree building algorithm is called recursively, so the values of C, LI, and N vary according to the current call stack (steps 310 and 312).

FIG. 3B illustrates an example embodiment of a hyperplane selection function 320 (CPF-SELECT-LEFT(N)) performed by the processor 106 at step 308 in FIG. 3A. The hyperplane selection function 320 is a novel function used to select, from a sorted subset of leaves, the coordinate defining the splitting hyperplane at the current node B[BI] of B. The number returned by the hyperplane selection function 320 is also the number of points in the left-sub tree at nodes where it is computed. The processor 106 executes the hyperplane selection function 320 to compute a value for the required size of the left sub-tree for the resulting KD-CPF Tree to be complete. The processor 106 computes the required size of the right sub-tree by subtracting this value from N.

Steps 322, 324, 326 and 328 illustrate how the processor 106 executes the hyperplane selection function 320 to implement a hyperplane selection rule as a function of N. At step 322, the call to the high bit (HIGH-BIT(N)) can be implemented using instructions available on the computer hardware used to implement hyperplane selection function 320, or by using built-in compiler equivalents. The hyperplane selection function 320 does not return the bit index of the highest set bit, but rather the actual numeric value represented by a computer word with only that bit set. Here, this value is referred to as T, which is a mnemonic for “two.” That is, T is a power of 2 defined such that N=T+R where R is strictly less than T. This statement uniquely defines the values T and R for any value of N.

At step 322, the processor 106 determines the values N, T, HT and R for a current splitting node of the k-dimensional tree. The value N is the total number of data points at the current splitting node of the tree. The value T is the high-bit number that is the largest number being a power of two that is less than or equal to the number of data points at the current splitting node (i.e., less than or equal to N). The value HT is half of the high-bit number (T) (i.e., HT=T/2). The value R is the difference between the total number of data points at the current splitting node (N) and the high-bit number (T) (i.e., R=N−T).

At step 324, the processor 106 compares the relative magnitude between (1) half of the high-bit number that is the largest number being a power of two that is less than or equal to the number of data points at the current splitting node (i.e., HT), and (2) the difference between the total number of data points at the current splitting node and the high-bit number (i.e., R). When half of the high-bit number (HT) is less than the difference between the total number of data points and the high-bit number (R), the hyperplane selection function 320 proceeds to step 326. When half of the high-bit number (HT) is not less than (i.e., greater than or equal to) the difference between the total number of data points and the high-bit number (R), the tree-building function 300 proceeds to step 328.

At step 326, the processor 106 selects the current splitting node of the k-dimensional tree using the high-bit number that is the largest number being a power of two that less than or equal to the number of data points as the size of the left sub-tree at the next node. In other words, the processor 106 selects the element defining the hyperplane using the high-bit number (T) as the number of data points for the left node that will be the child node at the top of the left sub-tree at the next level, and with the difference between the total number of data points at the current splitting node (N) and the high-bit number (T) as the number of data points for the right node that will be the child node at the top of the right sub-tree at the next level.

At step 328, the processor 106 selects the current splitting node of the k-dimensional tree using the sum of half of the high-bit number (HT) and the difference between the total number of data points at the current splitting node and the high-bit number (R). In other words, the processor 106 selects the element defining the hyperplane using the sum (HT+R) as the number of data points for the left node that will be the child node at the top of the left sub-tree at the next level, and with the difference between the number of data points at the current node (N) and the sum (HT+R) as the number of data points for the right node that will be the child node at the top of the right sub-tree at the next level.

As shown in FIG. 3A at steps 304 and 306, the processor 106 continues to execute the hyperplane selection function 320 to split each node of the k-dimensional tree until N=1 at the end of each branch, such that each branch of the KD-CPF tree terminates at a leaf node. FIGS. 4A and 4B illustrate how the hyperplane selection function 320 reduces memory requirements compared to an existing median selection method. FIG. 4A shows an example k-d tree built using the existing median selection method, while FIG. 4B shows a KD-CPF Tree built using the hyperplane selection function 320 of the present disclosure.

Referring first to FIG. 4A, an example k-d tree built using an existing median selection method is shown. The illustrated k-d tree has five levels L1 to L5, with the root node at the top level L1 being 10 (i.e., the example k-d tree has 10 data points, so N=10 at the top root level L1). As understood in the art, the median selection method splits each node in two. That is, the N=10 root node at the top level L1 splits into left and right child nodes of N=5 at the second level L2. Each of the N=5 child nodes at the second level L2 then splits into a left child node of N=3 and a right child node of N=2 at the third level L3, with 3 and 2 being the integers representing the median of 5. Each of the N=3 child nodes at the third level L3 then splits into a left child node of N=2 and a right child node of N=1 at the fourth level L4, with 2 and 1 being the integers representing the median of 3. Each of the N=2 child nodes at the third level L3 splits into left and right leaf nodes of N=1 at the fourth level L4, and each of the N=2 child nodes at the fourth level LA splits into left and right leaf nodes of N=1 at the fifth level L5. In the k-d tree shown in FIG. 4, there is wasted space for six nodes created by the gap in the fifth level L5.

FIG. 4B illustrates a KD-CPF Tree built using the hyperplane selection function 320 using the same root node of 10 at the top level L1. Applying step 322 to the top node of 10, N=10 (the number of data points), T=8 (the high-bit number that is a power of two and equal or less than 10), HT=4(T/2) and R=2(N−T). Since 4 (HT) is greater than 2 (R) at step 324, the hyperplane selection function 320 returns 6 (HT+R) as the high bit on the second level L2, splitting the first root node of 10 at 6/4 in the second level L2.

The nodes in the second level L2 are then split using the same process. Applying step 322 to the second level child node of 6, N=6 (the number of data points), T=4 (the high-bit number that is a power of two and equal or less than 6), HT=2(T/2) and R=2(N−T). Since 2 (HT) is equal to 2 (R) at step 324, the hyperplane selection function 320 returns 4(HT+R) as the high bit on the third level L3, splitting the child node of 6 at 4/2 in the third level L3.

The remaining nodes are also split using the same process. Applying block 322 to the child nodes of 4, N=4 (the number of data points), T=4 (the high-bit number that is a power of two and equal or less than 4), HT=2 (T/2) and R=0(N−T). Since 2 (HT) is greater than 0 (R) at block 324, the hyperplane selection function 320 returns 2 (HT+R) as the high bit on the subsequent level, splitting each node of 4 at 2/2. Similarly, applying step 322 to the child nodes of 2, N=2 (the number of data points), T=2 (the high-bit number that is a power of two and equal or less than 2), HT=1(T/2) and R=0(N−T). Since 1 (HT) is greater than 0 (R) at block 324, the hyperplane selection function 320 returns 1 (HT+R) as the high bit on the subsequent level, splitting each node of 2 at 1/1.

As seen in FIGS. 4A and 4B, the KD-CPF Tree built by the tree-splitting function 320 (FIG. 4B) does not contain the wasted memory space of the k-d tree built by the existing median split method (FIG. 4A). In other words, the KD-CPF Tree built by the tree-splitting function 320 (FIG. 4B) contains a 1-1 match between input data points (N) at the root node and number of leaf nodes, whereas the k-d tree built by the existing median split method (FIG. 4A) requires memory space for more leaf nodes than the input data points. Although FIGS. 4A and 4B illustrate a simple example with N=10 data points at the root node, the memory savings is more significant as the number of data points increases, considering that N at the root node is typically a very large number. Compared to the existing median selection method, the memory savings of a KD-CPF Tree built by the tree-splitting function 320 can generally be calculated as the order of (two to the power of the ceiling of log base 2 of N) minus N.

Referring again to step 308 in FIG. 3A, the notation assigning a value to B[BI] represents taking the current selected coordinate C from the point found in L at the index (LI+LeftN−1). This is the KD-CPF selection index determined by the value (LeftN) returned by the hyperplane selection function 320 of FIG. 4B. The statement in step 308 assigning a value to NextC from NEXT-C(C) chooses the next dimension to sort. For example, if C selects “x”, NEXT-C(C) in typical implementations returns a selection of “y”. When C selects the final point coordinate, typical implementations of NEXT-C(C) return a selection of START-COORD.

Step 310 in FIG. 3A is a recursive call processing the left sub-tree of B and L. As shown, the part of L processed in the recursive call begins at index LI, and has size LeftN. BI is set to the left child of BI. C is set to NextC, the next selected coordinate dimension. Similarly, step 312 is a recursive call processing the right sub-tree of B and L. As shown, the part of L processed in the recursive call begins at index LI+LeftN, and has size N-LeftN. BI is set to the right child of BI. C is set to NextC, the next selected coordinate dimension.

The method 300 thus builds B and L until the KD-CPF Tree is complete. Because the method 300 modifies L in-place, it is suitable for a memory constrained environment. By examining the values of LI and N set in steps 310 and 312, it can be seen that left and right sub-tree modifications to L affect disjoint, non-overlapping sections of memory. This property of the method 300 allows parallel processing of the recursive calls to be done with no synchronization, except upon completion.

FIGS. 5A and 5B illustrate a variant of the method shown in FIGS. 3A and 3B. The variant generally begins with machine-readable instructions 500 that define the inputs and call, along with the memory layout 112 as illustrated in FIG. 1. The machine-readable instructions 500 defines L and N as inputs as described above. T and R are defined as in FIG. 3B. The machine-readable instructions 500 exploit the recursive structure of the hyperplane selection function 320 of FIG. 3B by only computing the initial decomposition of N into T and R once at the beginning of the algorithm. LI and BI are implicitly initialized to zero (0) given as direct parameter values to the function call. Likewise, the initial value of C is directly given in the initial function call (START-COORD). Alternatively, as discussed above, one (1) can be used as the root of B, and BI can be initialized to one (1). Appropriate memory is allocated for B, knowing that the space of B will not change because the methods described herein do not requiring padding or discarding any data points. In this variant, N is always passed directly in two parts as T and R.

Once the variables are set, the processor 106 makes a call to hyperplane selection function 502 (CPF-KD-TREE-BUILDV2) shown in FIG. 5B with the initial values defined by the machine-readable instructions 500 in FIG. 5A. At steps 504 and 506, the processor 106 executes recursive calls until reaching a termination condition (here, N=1). As discussed above, once N reaches the value 1, there is no work remaining and the function returns at step 506, which expresses the completion logic when the algorithm is done and the KD-CPF Tree is complete.

Step 508 is similar to step 308 in FIG. 3A. A first operation (shown as IN-PLACE-SORT-ON-C) compares a coordinate C of points in L to determine the sort order. The sort is done over T+R points starting at an offset LI in the array L. The statement assigning a value to NextC from NEXT-C(C) at step 508 chooses the next dimension to sort.

At step 508, the processor 106 computes the value HT for use in the following steps. The processor 106 then implements a hyperplane selection rule as discussed above by proceeding to step 512 or 514 depending on the relative magnitude of R and HT. At step 512, the processor 106 assigns to B[BI] and makes recursive calls to compute the left and right sub-trees so that the left sub-tree has HT+R leaves and the right sub-tree has HT leaves. At step 514, the processor 106 assigns to B[BI] and makes recursive calls to compute the left and right sub-trees so that the left sub-tree has T leaves and the right sub-tree has R leaves.

Referring again to FIG. 2, at step 210 of the method 200, the generated KD-CPF Tree is complete and stored as an image of L, B and N. That is, the locations of the leaf nodes and the hyperplanes are stored in a memory accessible for a search of data associated with the data points, as discussed in more detail below. In an embodiment, the processor 106 causes the KD-CPF Tree to be stored on a local memory 108. More specifically, the processor 106 causes the KD-CPF Tree to be stored on the non-transitory machine-readable medium 108. Alternatively, the processor 106 causes the generated KD-CPF Tree to be stored on one or more remote memory 108. In an embodiment, the generated KD-CPF Tree on the memory of each of a fleet of vehicles so that it can be used to search data relevant to each vehicle.

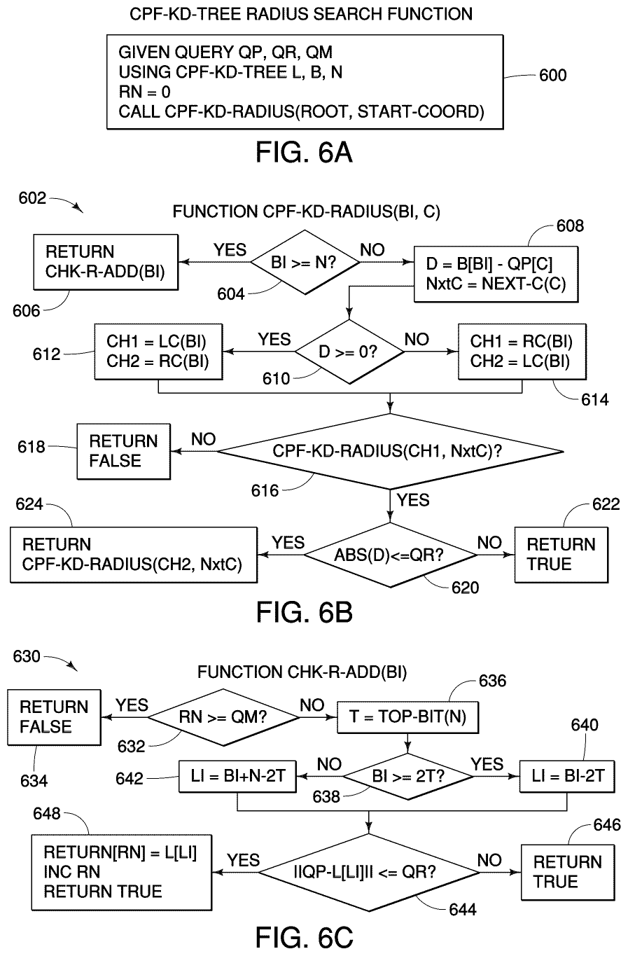

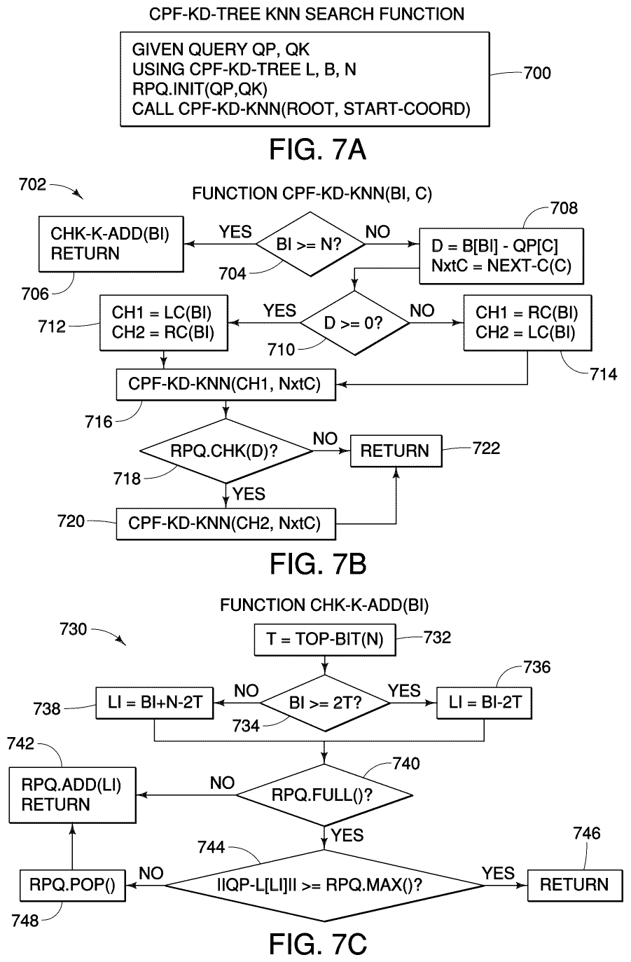

At step 212 of the method 200 shown in FIG. 2, the KD-CPF Tree built at step 208 and stored at step 210 can be used to search the data indexed by the KD-CPF Tree. FIGS. 6A to 6C illustrate an example embodiment of a radius searching method using a KD-CPF Tree built as described herein, while FIGS. 7A to 7C illustrate an example embodiment of a k-nearest neighbor (“knn”) searching method using a KD-CPF Tree built as described herein. The steps of these example embodiments are generally performed by the control unit 102 using the processor 106 to execute machine-readable instructions stored on the memory 108.

FIGS. 6A to 6C illustrate an example embodiment of a radius search using a KD-CPF Tree built in accordance with the present disclosure. The purpose of the radius search is to return points in the KD-CPF Tree within a query radius of a query point. This region is sometimes referred to as the “query circle.” An additional consideration of the radius search is to limit the maximum number of points in the response. The limit is practical since it is not known ahead of time how many points actually lie inside the query circle. This allows the application to allocate sufficient memory for the response.

Referring first to FIG. 6A, the memory 108 includes machine-readable instructions 600 which define variables and the call for the radius search. In the illustrated embodiment, QR represents the query radius, QP represents the query point, and QM represents the maximum number of points. The KD-CPF Tree is represented as L, B, N as defined in the memory layout 112 discussed above. The variable RN is set to zero (0) to track the returned number of points. With these variables initialized, the processor 106 makes top-level call to the radius searching function 602 (CPF-KD-RADIUS) shown in FIG. 6B, beginning with the root of the KD-CPF Tree using the initial search dimension (START-COORD).

FIG. 6B illustrates an example embodiment the radius searching function 602 (CPF-KD-RADIUS). At step 604, the processor 106 tests to determine if a leaf has been reached. BI indexes the search tree B (the KD-CPF Tree) to find the values defining the splitting planes. When BI exceeds the size of the binary tree B, BI is converted into a “found leaf index.” Step 606 returns true if it adds an element to the query results or if there is space remaining in the search results array. Step 606 returns false if there is no remaining space.

At step 606, the processor 106 returns the value of the adding function 630 (CHK-R-ADD) shown in FIG. 6C. At step 632, the processor 106 compares RN to QM to see if remaining space exists. If not, step 634 returns false. If there is remaining space, at steps 636, 638, 640 and 642, the processor 106 implements the conversion of the passed in BI index from the tree search of B into a leaf index LI which selects a leaf element from L. Once the leaf element L[LI] is selected, the distance between the leaf element and the query point QP can be computed, represented by the expression ∥QP−L[LI]∥at step 644. This distance is compared to the query radius QR at step 644. Step 646 returns true if the leaf L[LI] is outside the query radius. Step 648 adds a leaf L[LI] to the results array since it lies inside the query radius QR and returns a true value. For faster comparisons, ∥QP−L[LI]∥\hat{ }2<=QR\hat{ }2 can be used at step 644.

Referring again to FIG. 6B, at step 608 the processor 106 sets the variable D with the signed offset from the current split point in B[BI] and the C coordinate of the query point QP. The next coordinate is set to NxtC. At step 610, the processor 106 checks the sign of the variable D to pick which side of the splitting plane the query point lies on. Control then passes to step 612 when the query point is to the “left” of B[BI]. In this case CH1=LC(BI) sets the first child to search the left sub-tree, and the second child to search (CH2) is set to the right child. Otherwise, control passes to step 614 when the query point is to the “right” of B[BI]. In this case CH1=RC(BI) sets the first child to search the right sub-tree, and the second child to search (CH2) is set to the left child.

At step 616, the processor 106 executes the recursive search on the same side of B[BI] where the query point lies. As with step 606, the recursive calls return false when there is no more space for the result. If the function 602 returns false at step 616, control passes to step 618 returning the false result and ending the chain of recursive calls. Otherwise, at step 620, space remains in the results array, so the side of B[BI] opposite of where QP lies must be considered. A standard search discounts this side of the k-d tree if the one-dimensional distance D is greater than the full Euclidean distance QR. Step 622 returns true when space remains in results array and there is no need to search the opposite side of B[BI] from the query point QP. Step 624 returns the result of searching the opposite side of B[BI] from the query point QP.

FIG. 7A to 7C illustrate a knn search using a KD-CPF Tree built in accordance with the present disclosure. The purpose of the knn search is to return the k-closest points in the KD-CPF Tree to a query point.

Referring first to FIG. 7A, the memory 108 includes machine-readable instructions 700 which define variables and the call for the knn search. In the illustrated embodiment, the memory 108 defines the number of desired points k as QK and the query point as QP. The KD-CPF Tree is represented as L, B, N as defined in the memory layout 112 discussed above. The third line (RPQ.INIT(QP, QK)) represents initializing a priority queue. With these variables initialized, the processor 106 makes a top-level call to the knn searching function 702 (CPF-KD-KNN) from the root of the KD-CPF Tree using the initial search dimension (START-COORD).

Typical knn queries implement priority queues. The method shown in FIGS. 7A to 7C implements a modified priority queue. This situation comes about because k points are quickly found in a KD-CPF Tree during the knn search. At this point, the distance of the furthest of these k points from the query point serves as an upper bound. This upper bound is represented by a maximum value (RPQ.MAX) in FIG. 7C. As the search continues, any point found closer than the maximum value (RPQ.MAX) replaces this furthest point in the set of k results. The added point or another point already in the response then becomes the new upper bound. This process continues until the knn search terminates.

FIG. 7B illustrates an example embodiment of a knn searching function 702 using a KD-CPF Tree built in accordance with the present disclosure. At step 704, the processor 106 tests to determine if a leaf has been reached. BI indexes the search tree B to find the values defining the splitting planes of the KD-CPF Tree. When BI exceeds the size of the binary tree B, step 706 is reached, otherwise step 708.

At step 706, the processor 106 calls the adding function 730 (CHK-K-ADD) shown in FIG. 7C and returns. Steps 732, 734, 736 and 738 implement the conversion of the passed in BI index from the tree search of B into a leaf index LI which selects a leaf element from L. Step 740 checks if k elements are already saved in RPQ. If not, control passes to step 742, adding the element. The function then returns. If the RPQ is full, the distance from L[LI] to the query point, here represented as ∥QP−L[LI]∥, must be compared with RPQ.MAX( ) at step 744. If L[LI] is not closer, the function simply returns in block 746. If L[LI] is closer, the top element is first popped from RPQ in block 748. Then L[LI] is placed in RPQ in block 742. For faster comparisons, ∥QP−L[LI]∥\hat{ }2<=MAX( )\hat{ }2 can be used at step 744

Referring again to FIG. 7B, the processor 106 at step 706 calls the adding function 730 shown in FIG. 7C (CHK-K-ADD(BI)) and then returns. The adding function 730 determines whether the found leaf should be added to the set of k results. The processor 106 at step 708 sets the variable D with the signed offset from the current split point B[BI]. The next coordinate dimension is set to NxtC. The processor 106 at step 710 checks the sign of D to determine which side of the split point the query point lies on. Control passes to step 712 when the query point is to the “left” of B[BI]. In this case CH1=LC(BI) sets the first child to search the left sub-tree, and the second child to search (CH2) is set to the right child. Otherwise, control passes to step 714 when the query point is to the “right” of B[BI]. In this case CH1=RC(BI) sets the first child to search the right sub-tree, and the second child to search (CH2) is set to the left sub-tree.

At step 716, the processor 106 performs a recursive search on the side of B[BI] where the query point lies. When step 718 is reached, the side of B[BI] opposite of QP must be considered. The opposite side is always searched if less than k elements are in RPQ so far. If k elements are already present, the test skips this side of the tree if the one-dimensional distance D is greater than a maximum value (RPQ.MAX). This logic is encapsulated in an RPQ.CHK(D) function. Step 720 does the recursive search on the opposite side of B[BI] from the query point. Step 722 returns when the RPQ.CHK(D) method from step 718 returns false.

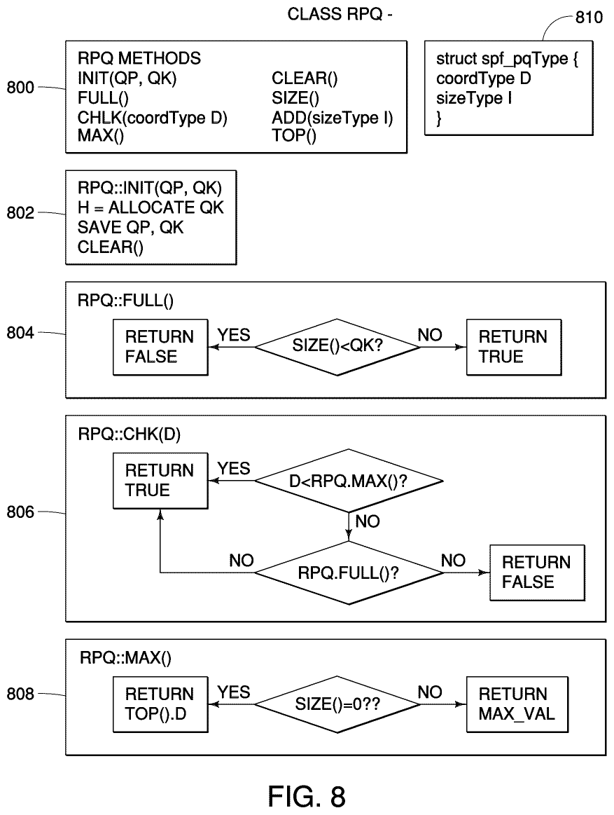

FIG. 8 illustrates example embodiments of source code for machine-readable instructions that can be used in the priority queue implementation supporting the knn searching method illustrated in FIGS. 7A to 7C. The methods in the left column of the machine-readable instructions 800 are added to support the knn search and are not part of a standard priority queue definition. The methods in the right column of the machine-readable instructions 800 are either standard priority queue methods, namely ADD( ) and TOP( ), or are standard C++container methods, namely CLEAR( ) and SIZE( ).

The machine-readable instructions 802 show the INIT( . . . ) method, which remembers the query parameters QP and QK for use during the search and allocates a heap (H) for the maximum number of elements that will be placed in the queue. The current number of elements is set to 0 by the CLEAR( ) function.

The machine-readable instructions 804 implement the FULL( ) function which returns true when QK elements are in the queue, and returns false otherwise.

The machine-readable instructions 806 implement the CHK(D) function. CHK(D) returns true or false at the point in knn search when a decision has to be made to search the side of the KD-CPF Tree opposite the query point QP.D is passed in as the one-dimensional distance from a splitting point in the KD-CPF Tree to the query point. If the queue is not full or D is less than MAX( ) in the queue already, the sub-tree must be searched and so CHK( ) returns true.

The machine-readable instructions 808 return the distance value of the maximal element in the priority queue. If the queue is empty, the maximum value possible for coordinate type (see coordType in FIG. 1) is returned. This test is added for logical consistency in case the MAX( ) function is called on an empty queue.

The machine-readable instructions 810 illustrate the data structure of elements stored the queue. Strictly speaking, only the index of the leaf element passed into the ADD( ) function is required in the queue. The structure spf_pqType has an extra field D to store the distance of the leaf L[I] from the query point QP. Since this distance is used to order elements in the queue and it does not change, computing the value once inside the ADD( ) function and storing it in the queue is simple and efficient.

Referring again to FIG. 2, at step 214 of the method 200, the processor 106 causes the results of the KD-CPF Tree search to be output and/or used. The results of the KD-CPF Tree search can be output and/or used as with existing k-d trees. In the vehicle navigation example discussed below, for example, the results of the KD-CPF Tree search can be output to a map ECU and/or used to build a localized map including map lanes, lane lines and lane objects such as cross walks, stop lines, traffic lights, etc. to assist a driver with navigation and/or be used by a vehicle for autonomous driving.

FIG. 9 illustrates an example embodiment of a system 900 configured to utilize a KD-CPF Tree built in accordance with the present disclosure. In the illustrated embodiment, the system 900 includes an electronic control unit (“ECU”) 902 having a data bus 904 configured to communicate via local and network connections to send and receive various types of data. Here, the system 900 is for a vehicle and the ECU 902 is the vehicle's navigation or map ECU (e.g., a map position unit or “MPU”).

In the illustrated embodiment, the ECU 902 generally includes an input processing system 906, an output processing system 908, and a map data system 910. The input processing system 906 is configured to group the input handlers that listen for and process information of interest from the data bus 904. The output processing system 908 is configured to group the publishers or output functions of the ECU 902. The map data system 910 generally describes the map data contained in the ECU 902 from which queries are made and responses published. The role of a KD-CPF Tree query in supporting these systems 906, 908, 910 is typically referred to as “localization,” which is a process of discovering map elements that correspond to or are associated with the current position or pose of objects in a part of the physical world represented by the map.

A KD-CPF Tree built as described herein enables the ECU 902 to quickly localize without searching every element of a map. More specifically, a KD-CPF Tree supports localization for routing, route following and finding map elements to publish. The specific details of which objects are searchable via points in the KD-CPF Tree, and even the number of KD-CPF Trees used, can vary significantly in different implementations. Since the KD-CPF Trees described herein are pointer-free, they can be freely moved around in memory or copied over a network and used as-is, making KD-CPF Trees ideal for a fleet of vehicles being shipped to different locations, since KD-CPF Tree can be configured with map information relevant to the respective location. A function to update map data on the ECU 902 can be implemented using a KD-CPF Tree image sourced from cloud data and immediately used, which is not possible with pointer-based k-d trees.

In the illustrated embodiment, the input processing system 906 generally includes a pose handler 912, a reset handler 914 and a waypoint handler 916. The output processing system 908 generally includes a lane line publisher 920, a route publisher 922, a route follower 924 and a decision object publisher 926. The map data system 910 generally includes a KD-CPF Tree 930 built as described herein, along with map data 932 that is indexed by the KD-CPF Tree 930.

The pose handler 912 is configured to handle pose data read off the local data bus 904. The ECU 902 can track position history and make periodic decisions to publish new data as the vehicle enters new areas of a map, which can trigger subsystems such as the lane line publisher 920 or the decision object publisher 922. The lane line publisher 920 publishes local information about nominal drivelines that can be used by modules such as a trajectory planning module 952.

The data bus 904 enables the ECU 902 to communicate with other local and nonlocal systems and modules. In the illustrated embodiment, the system 900 generally includes or is in communication with a global navigation satellite subsystem (“GNSS”)/inertial measurement unit (“IMU”) 940, a reset module 942, a route waypoints module 944, a gateway cell mobile device management (“MDM”) module 946, a decision-making module 948, a tracking and prediction module 950, and a trajectory planning module 952. In an embodiment, these or other systems and modules can be data sources 104 as discussed above and/or can use the results of KD-CPF Tree search queries when performing operations.

Position information from the GNSS/IMU 940 or the route waypoints module 944 can be directly used in queries of the KD-CPF Tree 930. For localization input, the GNS/IMU 940 and the route waypoints module 944 provide coordinate data that is used as an input to KD-CPF Tree 930 query functions, such as the example radius search shown in FIGS. 6A to 6C and/or the example knn search shown in FIGS. 7A to 7C.

The reset module 942 generally represents a bus command that can purposely cause the ECU 902 to “forget” that it has already published data. A reset can be used when new subsystems come online or where data loss has occurred. After the ECU 902 has processed a reset, the ECU 902 will typically publish data associated with subsequent pose handler 912 or waypoint handlers 916 immediately.

The gateway or cell MDM 946 generally represents a connection point to the internet from the vehicle and supports various protocols which exchange data between the vehicle and a cloud network.

The decision-making module 948, the tracking and prediction module 950, and the trajectory planning modules 952 are typical consumers of map data from the map data system 910. Each of these modules 948, 950, 952 utilizes different subsets of the map data. The decision-making module 948 generally utilizes traffic control information such as stop lines, cross walks, traffic signals, stop and yield signs, etc. The tracking and prediction subsystem 950 generally utilizes map information that describes areas by type, such as sidewalks, road areas, boundaries such as curbs, etc., which can be used to place objects on a map and predict future behavior. The trajectory planning subsystem 952 generally utilizes lane lines (aka drive lines) and other restrictive information (e.g., left-turn-only) which can be used to plan smooth control of a vehicle over a nominal drive path. The prediction aspect of the tracking and prediction subsystem 950 also generally uses the restrictive information. Each of these modules 948, 950, 952 can use the results of KD-CPF Tree search queries when performing operations.

In an embodiment, the ECU 902 is configured to determine whether to use a knn search or a radius search for the KD-CPF Tree 930. The determination generally depends on the distribution of points in the map and a-priori knowledge of how the input pose relates to the map. For example, in maps built with an uneven point distribution, a radius search will produce different numbers of points inside a fixed radius search, depending on where in the map the query is performed. Overflow in a radius search is undesirable, since it is impossible to know which points are missing. A radius search is desirable where some knowledge of positioning error is available so that a radius search at least as large as this error includes the true adjacent elements in the search results.

Another consideration is that if the relation of the current position to the current map data is unknown, a knn search will return the k nearest points regardless of their distance. A radius search provides no information about map elements outside the search radius. These and other considerations make the availability of both knn and radius searches desirable to the ECU 902 functions so that the ECU 902 can perform the optimal search for any situation. For route generation, waypoints (e.g. at the position handler 912 or the NT. waypoint handler 916) are used as inputs to a KD-CPF Tree query to find lane positions matching the waypoints. Once this is done, standard path optimization algorithms can be used to compute a route (represented as lane sequences) including all lane positions corresponding to the waypoints. Similarly, the route follower 924 is configured to use a KD-CPF Tree search to find map elements close to the positions produced by the GNSS/IMU 940 to evaluate how well the vehicle is progressing along a previously computed route (e.g., from the route publisher 922).

In the illustrated embodiment, the ECU 902 includes at least one KD-CPF Tree 930. Every map element that can be searched using the KD-CPF Tree 930 contributes points during the build phase. Referring back to the example leaf types 114 in FIG. 1, the third example provides a leaf definition for this embodiment, where a lane identification (laneId) and a position (positionIndex) is associated with every point. In this embodiment, the KD-CPF Tree 930 stores points making up the drivelines associated with the lanes. When the ECU 902 needs to use KD-CPF Tree 930 for localization, the returned leaves from radius or knn queries allow the localization to immediately look up the lane objects associated with the returned leaves using the lane identification (laneId). The position in this lane is then immediately given by the position index (positionIndex).

The KD-CPF Tree 930 directly and indirectly supports many efficient operations of the ECU 902. For example, the KD-CPF Tree 930 can be used to find map elements supporting functions such as the lane line publisher 920 and the decision object publisher 926. The lane line publisher 920 can immediately publish the map lanes found in the search. The map lanes also typically have associated data links as part of the lane object. The decision object publisher 926 can thus also immediately publish objects such as cross walks, stop lines, traffic lights, etc. found via the lanes that refer to them, even if not found by a direct search via KD-CPF Tree 930. Thus, these and other results of radius search or the k-nearest neighbor search can be output (e.g., at step 214 of the method 200), for example, to a vehicle module that assists a driver with navigation or assists a vehicle with autonomous driving.

In an embodiment, the handlers (e.g., handlers 912, 914, 916) receive the KD-CPF Tree 930 and updated map data from a cloud network. Since the KD-CPF Tree 930 contains no pointers, it can be used as-is upon being read from the cloud network.

In an embodiment, the handlers (e.g., handlers 912, 914, 916) process perception data to modify map elements. In this embodiment, the build routines (e.g., the methods of FIGS. 3 and 5), can be implemented on the ECU 902 to build a new KD-CPF Tree 930 using the points in the modified map elements.

In an embodiment, the data discussed herein can be included in a “shared memory.” This requires hardware support for multi-processor computers, or can be done between multiple processes on typical modern operating systems. The KD-CPF Tree discussed herein is well-suited to use in a shared memory presentation since no pointers are present.

The disclosed KD-CPF Trees are particularly advantageous for map-ECUs 902 (or MPUs), for example, because the KD-CPF Tree image is ideal for flashing onto an ECU ROM, the simple search implementation is suitable for low compute power, local network clients can use the KD-CPF Tree image published as-is, and the pointer-free image enables the same client to use a cloud or MPU source data.

Those of ordinary skill in the art will recognize from this disclosure that further variations of the disclosed KD-CPF Trees can also be used to improve memory and processing efficiency. For example, a knn search can be sped up using a priority queue instead of updating a results array. Recursive calls can be modified to use a queue instead of a stack. Sorts can be replaced with quickselect or other order statistic selection algorithms for a faster build. The KD-CPF Tree search indexing can be further simplified by reordering the leaves after the build. Simplified coding for sub-tree's where N−T=0 can also result in a faster build.

The embodiments described herein provide systems and methods for generating a k-dimensional complete pointer-free tree. These systems and methods are advantageous, for example, because they reduce memory requirements, improve search processing efficiency and build k-d trees which can be freely moved around in memory or copied over a network and used as-is. It should be understood that various changes and modifications to the systems and methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A computer-implemented method of building a k-dimensional complete pointer-free tree (“KD-CPF tree”) for a plurality of data points, the method comprising:
determining a number of data points for constructing a KD-CPF tree having a plurality of splitting nodes and a plurality of leaf nodes;
for each respective splitting node of the plurality of splitting nodes, determining a relative magnitude between (i) half of a high-bit number that is a largest number being a power of two that is less than or equal to the number of data points at the respective splitting node, and (ii) the difference between the number of data points at the respective splitting node and the high-bit number;
based on the relative magnitude, splitting each of the respective splitting nodes with a hyperplane that places a number of points on a left side of the hyperplane equal to one of (a) the high-bit number or (b) a sum of half of the high-bit number and the difference between the number of data points at the respective splitting node and the high-bit number, until each branch of the KD-CPF tree terminates at a leaf node; and
storing locations of the leaf nodes and the hyperplanes in a memory accessible for a search of data associated with the data points.

2. The method of claim 1, comprising
when half of the high-bit number is less than the difference between the number of data points at the respective splitting node and the high-bit number, splitting the respective splitting node using the high-bit number.

3. The method of claim 1, comprising
when half of the high-bit number is not less than the difference between the number of data points at the respective splitting node and the high-bit number, splitting the respective splitting node using the sum of half of the high-bit number and the difference between the number of data points at the respective splitting node and the high-bit number.

4. The method of claim 1, comprising
when half of the high-bit number is less than the difference between the number of data points at the respective splitting node and the high-bit number, splitting the respective splitting node of using the high-bit number, and
when the half of the high-bit number is not less than the difference between the number of data points at the respective splitting node and the high-bit number, splitting the respective splitting node using the sum of half of the high-bit number and the difference between the number of data points at the respective splitting node and the high-bit number.

5. The method of claim 1, comprising
storing the locations of the leaf nodes and the hyperplanes on respective electronic control units of a plurality of vehicles.

6. The method of claim 1, comprising
before splitting the plurality of splitting nodes, defining a size of a memory location for the KD-CPF tree based on the number of data points.

7. A non-transitory machine-readable medium storing instruction which, when executed by one or more processor, cause the one or more processor to execute the method of claim 1.

8. A non-transitory machine-readable medium storing source code instructions which, when executed by one or more processor, cause the one or more processor to build a k-dimensional complete pointer-free tree (“KD-CPF tree”) for a plurality of data points, the non-transitory machine readable medium storing source code instructions comprising:
a memory layout defining a first memory location, a second memory location, and a value indicating a number of data points; and
a hyperplane selection function configured to build the first memory location and the second memory location by recursively splitting a plurality of respective nodes using a test based on a relative magnitude between (i) half of a high-bit number that is a largest number being a power of two that is less than or equal to a number of data points of the respective node, and (ii) the difference between the number of data points at the respective node and the high-bit number.

9. The non-transitory machine-readable medium of claim 8, wherein
the first memory location includes a leaf index, and
the second memory location includes a binary tree index.

10. The non-transitory machine-readable medium of claim 8, comprising
a coordinate type defining coordinates for each data point in the first memory location.

11. The non-transitory machine-readable medium of claim 8, comprising
a data type defining data associated with each data point in the first memory location.

12. The non-transitory machine-readable medium of claim 8, wherein
the memory layout defines a size of the first memory location and the second memory location based on the value indicating the number of data points.

13. The non-transitory machine-readable medium of claim 8, wherein
the hyperplane splitting function is configured to split the respective node using the high-bit number when half of the high-bit number is less than the difference between the number of data points at the respective node and the high-bit number, and
the hyperplane splitting function is configured to split the respective node using the sum of half of the high-bit number and the difference between the number of data points at the respective node and the high-bit number when half of the high-bit number is not less than the difference between the number of data points at the respective node and the high-bit number.

14. A vehicle electronic control unit comprising the non-transitory machine-readable medium of claim 8.

15. A computer-implemented method of searching a k-dimensional complete pointer-free tree (“KD-CPF tree”), the method comprising:
storing a KD-CPF tree that defines splitting hyperplanes for a plurality of respective nodes using a test based on a relative magnitude between (i) half of a high-bit number that is a largest number being a power of two that is less than or equal to a number of data points of the respective node, and (ii) the difference between the number of data points at the respective node and the high-bit number;
searching the KD-CPF tree using a radius search or a k-nearest neighbor search; and
outputting results of the radius search or the k-nearest neighbor search.

16. The method of claim 15, comprising
copying the KD-CPF tree onto respective electronic control units for a plurality of vehicles, and
using the radius search or the k-nearest neighbor search on the KD-CPF tree to search map data relevant to a respective vehicle.

17. The method of claim 16, comprising
outputting results of the radius search or the k-nearest neighbor search to a vehicle module that assists a driver with navigation or assists a vehicle with autonomous driving.

18. The method of claim 15, wherein
searching the KD-CPF tree includes indexing the KD-CPF tree to find values defining the splitting hyperplanes.

19. A non-transitory machine-readable medium storing instruction which, when executed by one or more processor, cause the one or more processor to execute the method of claim 15.

20. A vehicle electronic control unit comprising the non-transitory machine-readable medium of claim 19, wherein the KD-CPF tree indexes map data.
